(19) United States
(12) Patent Application Publication
(10) Pub. No.: US 2015/0200036 A1
(43) Pub. Date: Jul. 16, 2015

(54) EMULSIONS FOR PREPARING TRANSPARENT CONDUCTIVE COATINGS

(71) Applicant: Cima NanoTech Israel Ltd., Caesarea (IL)

(72) Inventors: Arkady Garbar, Burnsville, MN (US); Ira Perelshtein-Elbaz, Or Akiva (IL)

(73) Assignee: Cima Nano Tech Israel Ltd., Caesarea (IL)

(21) Appl. No.: 14/420,565

(22) PCT Filed: Aug. 15, 2013
(86) PCT No.: PCT/US2013/055168

§ 371 Date: Feb. 9, 2015

Related U.S. Application Data
(60) Provisional application No. 61/683,798, filed on Aug. 16, 2012.

(51) Int. Cl. H01B 1/22

(52) U.S. Cl. CPC H01B 1/22

(57) ABSTRACT

A composition comprising metal nanoparticles dispersed in a liquid carrier that includes a continuous liquid phase and a dispersed liquid phase, where the composition is in the form of an emulsion. One of the continuous liquid phase or dispersed liquid phase includes at least 40 percent by weight, based upon the total weight of the composition, of an aqueous phase, and the other of the continuous liquid phase or dispersed liquid phase includes an oil phase that evaporates more quickly than the aqueous phase. The metal nanoparticles are present in an amount no greater than 4 percent by weight, based upon the total weight of the composition. When the emulsion is coated onto a surface of a substrate and dried to remove the liquid carrier, the metal nanoparticles self-assemble to form a coating comprising a network-like pattern of electrically conductive traces defining cells that are transparent to light.

### CROSS-REFERENCE TO RELATED APPLICATIONS

This application claims the benefit of U.S. Provisional Application Ser. No. 61/683,798, filed Aug. 16, 2012. The disclosure of the prior application is considered part of (and is incorporated by reference in) the disclosure of this application.

### TECHNICAL FIELD

This invention relates to preparing transparent conductive articles.

### BACKGROUND

Transparent conductive coatings are useful in a variety of electronic devices. These coatings provide a number of functions such as electromagnetic (EMI shielding) and electrostatic dissipation, and they serve as light transmitting conductive layers and electrodes in a wide variety of applications. Such applications include, but are not limited to, touch screen displays, wireless electronic boards, photovoltaic devices, conductive textiles and fibers, organic light emitting diodes (OLEDs), electroluminescent devices, heaters, and electrophoretic displays, such as e-paper.

Transparent conductive coatings such as those described in U.S. Pat. Nos. 7,566,360; 7,601,406; 7,736,693; and 8,105,472 are formed from the self-assembly of conductive nanoparticles coated from an emulsion onto a substrate and dried. Following the coating step, the nanoparticles self-assemble into a network-like conductive pattern of randomly-shaped cells that are transparent to light.

### SUMMARY

A composition is described that includes metal nanoparticles dispersed in a liquid carrier that includes a continuous liquid phase and a dispersed liquid phase. The composition is in the form of an emulsion. One of the continuous liquid phase or dispersed liquid phase includes at least 40% by weight, based upon the total weight of the composition, of an aqueous phase, and the other of the continuous liquid phase or dispersed liquid phase includes an oil phase that evaporates more quickly than the aqueous phase. The metal nanoparticles are present in an amount no greater than 4% by weight, based upon the total weight of the composition. When the emulsion is coated onto a surface of a substrate and dried to remove the liquid carrier, the metal nanoparticles self-assemble to form a coating comprising a network-like pattern of electrically conductive traces defining cells that are transparent to light at wavelengths in the range of 370 to 770 nm. The coating exhibits shading percentage of no greater than 8% and a sheet resistance of no greater than 50 ohms/square.

The term “nanoparticles,” as used herein, refers to fine particles small enough to be dispersed in a liquid to the extent they can be coated and form a uniform coating. This definition includes particles having an average particle size less than about three micrometers. For example, in some implementations, the average particle size is less than one micrometer, and in some embodiments the particles measure less than 0.1 micrometer in at least one dimension.

The term “shading percentage,” as used herein, is a measure of transparency that is independent of contributions from the underlying substrate is shading percentage. It is calculated according to the following formula: (1-% T emulsion coated substrate/% T uncoated substrate)×100%, where “% T” refers to “percent transmittance.” As used herein, “uncoated” refers to the substrate prior to application of the emulsion.

In some implementations, the shading percentage is no greater than 7%. The sheet resistance may be no greater than 20 ohms/square, while in other implementations it is no greater than 10, 5, or 4 ohms/square. The amount of metal nanoparticles may be no greater than 2% by weight or no greater than 1% by weight, based upon the total weight of the composition. Examples of suitable metal nanoparticles include a metal element selected from the group consisting of silver, gold, platinum, palladium, nickel, cobalt, copper, and combinations thereof.

The coating compositions can be used to prepare transparent conductive coatings, and articles including these coatings, that exhibit high transparency (as measured by low shading percentage values) and high electrical conductivity (as measured by low sheet resistance values), but with low loadings of metal nanoparticles.

The details of one or more embodiments of the invention are set forth in the description below. Other features, objects, and advantages of the invention will be apparent from the description and from the claims.

### DETAILED DESCRIPTION

A composition in the form of a liquid emulsion containing metal nanoparticles is used to form a transparent conductive layer on a first substrate. The emulsion includes a liquid carrier having an aqueous phase and an oil phase. One of the phases forms a continuous liquid phase. The other phase forms dispersed domains within the continuous liquid phase. In some implementations, the continuous phase evaporates more quickly than the dispersed phase. One example of a suitable emulsion is a water-in-oil emulsion, where water is the dispersed liquid phase and the oil provides the continuous phase. The emulsion can also be in the form of an oil-in-water emulsion, where oil provides the dispersed liquid phase and water provides the continuous phase.

The oil phase can include an organic solvent. Suitable organic solvents may include petroleum ether, hexanes, heptanes, toluene, benzene, dichloroethane, trichloroethylene, chloroform, dichloromethane, nitromethane, dibromomethane, cyclopentanone, cyclohexanone or any mixture thereof. Preferably, the solvent or solvents used in this oil phase are characterized by higher volatility than that of the water phase.

Suitable materials for the aqueous phase can include water and/or water-miscible solvents such as methanol, ethanol, ethylene glycol, propylene glycol, glycerol, dimethyl formamide, dimethyl acetamide, acetonitrile, dimethyl sulfoxide, N-methyl pyrrolidone. The amount of the aqueous phase is at least 40% by weight, based upon the total weight of the emulsion.

The emulsion may also contain at least one emulsifying agent, binder or any mixture thereof. Suitable emulsifying agents can include non-ionic and ionic compounds, such as the commercially available surfactants SPAN®-20 (Sigma-Aldrich Co., St. Louis, Mo.), SPAN®-40, SPAN®-60, SPAN®-80 (Sigma-Aldrich Co., St. Louis, Mo.), glyceryl monooleate, sodium dodecylsulfate, or any combination thereof. Examples of suitable binders include modified cellulose, such as ethyl cellulose with a molecular weight of about 100,000 to about 200,000, and modified urea, e.g., the commercially available BYK®-410, BYK®-411, and BYK®-420 resins produced by BYK-Chemie GmbH (Wesel, Germany).

Other additives may also be present in the oil phase and/or the water phase of the emulsion formulation. For example, additives can include, but are not limited to, reactive or non-reactive diluents, oxygen scavengers, hard coat components, inhibitors, stabilizers, colorants, pigments, IR absorbers, surfactants, wetting agents, leveling agents, flow control agents, thixotropic or other rheology modifiers, slip agents, dispersion aids, defoamers, humectants, sintering enhancers, adhesion promoters, and corrosion inhibitors.

The metal nanoparticles may be comprised of conductive metals or mixture of metals including metal alloys selected from, but not limited to, the group of silver, gold, platinum, palladium, nickel, cobalt, copper or any combination thereof. Preferred metal nanoparticles include silver, silver-copper alloys, silver palladium or other silver alloys or metals or metals alloys produced by a process known as Metallurgic Chemical Process (MCP) described in U.S. Pat. Nos. 5,476,535 and 7,544,229. The metal nanoparticles are included in the emulsion in an amount no greater than 4% by weight, based upon the total weight of the composition. In some implementations, the amount of metal nanoparticles is no greater than 2% by weight or no greater than 1% by weight, based upon the total weight of the composition.

The metal nanoparticles mostly, though not necessarily exclusively, become part of the traces of the conductive network. In addition to the conductive particles mentioned above, the traces may also include other additional conductive materials such as metal oxides (for example ATO or ITO) or conductive polymers, or combinations thereof. These additional conductive materials may be supplied in various forms, for example, but not limited to particles, solution or gelled particles.

Examples of suitable substrates for the first substrate include glass, paper, metal, ceramics, textiles, printed circuit boards, and polymeric films or sheets. The first substrate can be flexible or rigid. Suitable polymeric films can include polyesters, polyamides, polyimides (e.g., Kapton® by Dupont in Wilmington, Del.), polycarbonates, polyethylene, polyethylene products, polypropylene, polyesters such as PET and PEN, acrylate-containing products, polymethyl methacrylates (PMMA), epoxy resins, their copolymers or any combination thereof.

In order to improve certain properties, the substrate may be pre-treated and/or may have a preliminary coating layer applied prior to the coating of the emulsion. For example, the substrate may have a primer layer to improve coating adhesion, or the substrate may have a hard-coat layer applied in order to provide mechanical resistance to scratching and damage. Examples of suitable primers include polymeric coatings such as acrylic coatings (e.g., UV-cured acrylic coatings).

Pretreatment may be performed, for example, to clean the surface or alter it by physical means or chemical means. Such means include, but are not limited to, corona, plasma, UV-exposure, laser, glow discharge, microwave, flame treatment, chemical etching, mechanical etching, and printing. Such treatments can be applied to neat substrates or to substrates for which the film supplier has already placed a primer, preliminary coating, or otherwise pretreated the surface of the substrate.

The coating composition can be prepared by mixing all components of the emulsion. The mixture can be homogenized using an ultrasonic treatment, high shear mixing, high speed mixing, or other known methods used for preparation of suspensions and emulsions.

The composition can be coated onto the first substrate using bar spreading, immersing, spin coating, dipping, slot die coating, gravure coating, flexographic plate printing, spray coating, or any other suitable techniques. In some implementations, the homogenized coating composition is coated onto the first substrate until reaching a thickness of about 1 to 200 microns, e.g., 5 to 200 microns.

After applying the emulsion to the first substrate; the liquid portion of the emulsion is evaporated, with or without the application of heat. When the liquid is removed from the emulsion, the nanoparticles self-assemble into a network-like pattern of conductive traces defining cells that are transparent to light in the range of 370 to 770 nm. One measure of transparency that is independent of contributions from the underlying substrate is shading percentage, which is calculated according to the following formula: (1-% T emulsion coated substrate/% T uncoated substrate)×100%, where “% T” refers to “percent transmittance.” The network-like pattern of conductive traces formed using the above-described emulsions has a shading percentage no greater than 8%. In some implementations, the shading percentage is no greater than 7%. At the same time, the pattern of traces exhibits a sheet resistance no greater than 50 ohms/square. In some implementations, the sheet resistance is no greater than 20 ohms/square, while in other implementations it is no greater than 10, 5, or 4 ohms/square.

In some implementations, the cells are randomly shaped. In other implementations, the process is conducted to create cells having a regular pattern. An example of such a process is described in PCT/US2012/041348 entitled “Process for Producing Patterned Coatings,” filed Jun. 7, 2012, which is assigned to the same assignee as the present application and hereby incorporated by reference in its entirety. According to this process, the composition is coated on a surface of the first substrate and dried to remove the liquid carrier while applying an outside force during the coating and/or drying to cause selective growth of the dispersed domains, relative to the continuous phase, in selected regions of the substrate. Application of the outside force causes the non-volatile component (the nanoparticles) to self-assemble and form a coating in the form of a pattern that includes traces defining cells having a regular spacing (for instance, a regular center-to-center spacing), determined by the configuration of the outside force. Application of the outside force may be accomplished, for example, by depositing the composition on the substrate surface and then passing a Mayer rod over the composition. Alternatively, the composition can be applied using a gravure cylinder. In another implementation, the composition may be deposited on the substrate surface, after which a lithographic mask is placed over the composition. In the case of the mask, as the composition dries, the mask forces the composition to adopt a pattern corresponding to the pattern of the mask.

In each case, it is the outside force that governs the pattern (specifically, the center-to-center spacing between cells in the dried coating). However, the width of the traces defining the cells is not directly controlled by of the outside force. Rather, the properties of the emulsion and drying conditions are the primary determinant of the trace width. In this fashion, lines substantially narrower than the outside force can be readily manufactured, without requiring the difficulty and expense of developing processes, masters, and materials having very fine linewidth. Fine linewidth can be generated with the emulsion and drying process. However, the outside force can be used (easily and inexpensively) to control the size, spacing, and orientation of the cells of the network.

Following liquid removal, the coated substrate may be dried and, optionally, sintered to improve conductivity. Sintering may be accomplished by heating, chemical treatment, or a combination thereof.

In some implementations, the cells of the pattern may be at least partially filled with fillers in the form of a glue, pressure sensitive adhesive (PSA), or heat sensitive adhesive that will adhere or laminate an additional layer (polymer, substrate, etc.) on top of the transparent conductive layer. This structure allows removal of the original substrate on which the transparent conductive coating is formed, thereby exposing the smooth side of the transparent conductive coating layer that may be desirable in subsequent device construction or in facilitating transfer to a more desirable substrate for a particular product application. Epoxy adhesives or UV curable acrylic adhesives are examples of adhesive filler materials.

In some implementations, a curable silicone composition may be applied over the coated substrate using, e.g., bar spreading, immersing, spin coating, dipping, slot die coating, gravure coating, flexographic plate printing, spray coating, or any other suitable techniques, as disclosed in USSN 61/604,127 entitled “Transparent Conductive Coatings on an Elastomeric Substrate,” filed Feb. 28, 2012, which is assigned to the same assignee as the present application and hereby incorporated by reference in its entirety. The curable silicone coating composition may be coated onto the first substrate until reaching a wet thickness of about 0.1 to 10 mm. Examples of suitable curable silicone coating compositions include alkyl, aryl, alkylaryl, and fluorosilicones, with polydimethylsiloxane compositions being preferred. Following coating, the silicone composition is cured, e.g., by heating it to form a crosslinked silicone substrate having a thickness on the order of 0.5 mm to 10 mm. The particular thickness is selected to create an elastomeric silicone substrate that is free-standing (i.e. can be handled without the aid of an additional supporting layer). The crosslinked silicone substrate is then separated/peeled from the first substrate to transfer the dried transparent, conductive coating from the first substrate to the silicone substrate.

### EXAMPLES

Test Methods

% Transmittance (%T)

% Transmittance is the average percent of light that is transmitted through a sample at wavelengths between 400-740nm with a 20nm resolution as measured by a GretagMacbeth Color Eye 3000 Spectrophotometer with an integrated sphere (X-rite Corp, Grand Rapids, Mich.). U46 PET, as received from the manufacturer, had a % transmittance of 91.3%. U46 PET, coated with the primer used with Examples 7-15, below, had a % transmittance of 91.5%. The primers contemplated for use with the emulsions described herein typically have no effect on the transmittance.

% Shading

% Shading was calculated using the following formula: (1- % T emulsion coated substrate/% T uncoated substrate)×100%

Sheet Resistance (Rs)

Sheet resistance was measured using a Loresta-GP MCP T610 4 point probe (Mitsubishi Chemical, Chesapeake, Va.).

Glossary

| Component | Function | Chemical description | Source |
|---|---|---|---|
| BYK-410 | Liquid | Solution of a modified urea | BYK USA, |
| | rheology | | Wallingford, |
| | additive | | CT |
| K-Flex A307 | Flexibility | Linear, saturated, aliphatic polyester | King |
| | modifier | diol with primary hydroxyl groups | Industries, |
| | | | Norwalk, CT |
| Span 60 | | Sorbitan monostearate | Sigma- |
| | | | Aldrich, St. |
| | | | Louis, MO |
| Nacure 2501 | Blocked acid | Amine blocked toluenesulfonic acid | King |
| | catalyst | | Industries |
| BYK-348 | Silicone | Polyether modified | BYK USA |
| | surfactant | polydimethylsiloxane | |
| P204 | Silver | Silver nanoparticle powder | Cima |
| | nanoparticles | | Nanotech, |
| | | | Inc., Israel |
| Q4-3667 fluid | | Silicone polyether (glycol) copolymer | Dow Corning, |
| | | | Midland, MI |
| Ethyl | | | Sigma- |
| cellulose | | | Aldrich |
| Synperonic | | Polyethylene glycol nonylphenyl | Fluka, Sigma- |
| NP-30 | | ether | Aldrich |
| Cymel 303 | Cross-linking | Hexamethoxymethyl melamine | Cytec |
| | agent | | Industries |
| EN 1540 | Surfactant | Polyoxyethylene Oleyl Ether (EO: 40 moles), | Aoki Oil |
| | | sold under the name Blaunon | Industrial Co., |
| | | EN 1540 | Osaka, Japan |
| SR 610 | Diacrylate | Polyethylene glycol (600) diacrylate | Sartomer Co., |
| | monomer | | Exton, PA |
| SR 238B | Diacrylate | 1,6-Hexanediol diacrylate | Sartomer Co., |
| | monomer | | Exton, PA |
| Esacure One | Photoinitiator | Difunctional alpha hydroxy ketone | Lamberti |
| | | | S.p.A., Italy |

Formulations

Primer

The components shown in Table 1 were mixed until uniform and coated at 12 microns wet thickness on PET film (Lumirror U46, Toray Industries, Japan) using a Mayer rod. The coating was dried at room temperature for 1 min. and UV cured by passing through a system having an F300S UV curing lamp with an H bulb on an LC6B

Conveyor (Fusion UV Systems Inc., Gaithersburg, Md.) at about 4.6 meters/min.

TABLE 1
Primer Components

| | Examples 1-4 | Examples 5-6* | Examples 7-15 |
|---|---|---|---|
| Component | (wt %) | (wt %) | (wt %) |
| BYK 348 | 0.13 | 0.11 | 0.12 |
| SR 610 | 12.60 | 12.67 | 12.56 |
| SR 238B | 5.40 | 5.37 | 5.42 |
| Esacure One | 1.16 | 0.94 | 1.30 |
| Ethanol | 80.71 | 80.92 | 80.60 |

*These exampes were passed through the UV curing treatment twice.

Emulsion

The components shown in Table 2 were mixed in the following manner. All of the components except the deionized (“D.I.”) water were mixed until uniform using an ultrasonic homogenizer to form a dispersion. Next, the D.I. water was added and mixed using an ultrasonic homogenizer to form a uniform emulsion.

The uniform emulsion was coated onto the primed PET film using a Mayer rod at 30 microns wet thickness (Examples 8 and 12 were coated at 24 microns wet thickness). The coated films were dried at temperatures indicated in Table 3, during which time the conductive network self-assembled. Next, the films were heated at 150 deg. C. for 2 minutes, dipped in 1M HC1 for 1 min., washed with D.I. water, and dried for 1-2 min. at 150 deg. C.

TABLE 2
Emulsion components

| | | Examples | |
|---|---|---|---|
| | Examples 1-6 | 7-8 & 11-15 | Examples 9-10 |
| Component | (wt %) | (wt %) | (wt %) |
| BYK 410 | 0.13 | 0.14 | 0.14 |
| Span 60 | 0.11 | 0.11 | 0.11 |
| Cyclohexanone | 3.89 | 4.14 | 4.12 |
| P204 | 3.43 | 3.65 | 3.63 |
| Toluene | 42.96 | 45.67 | 45.49 |
| Cymel 303 | 0.13 | 0.13 | 0.13 |
| Kflex A307 | 0.15 | 0.16 | 0.16 |
| Nacure 2501 | 0.25 | 0.27 | 0.27 |
| Q4-3667 (5 wt % in | 0.51 | 0.54 | 0.53 |
| toluene) | | | |
| Ethyl cellulose (5 wt % | 0.61 | 0.64 | 0.64 |
| in toluene) | | | |
| Synperonic NP-30 | 0.37 | 0.39 | 0.39 |
| (1 wt % in toluene) | | | |
| 2-amino-1-butanol | 0.11 | 0.12 | 0.12 |
| Aniline | 0.06 | 0.07 | 0.07 |
| D.I. Water with 0.02 wt | 47.30 | 43.97 | 43.82 |
| % BYK 348 | | | |
| EN 1540 (1 wt % in | 0 | 0 | 0.38 |
| toluene) | | | |

The coated films were tested for light transmittance and resistance, with results shown in Table 3.

TABLE 3
Results

| | Drying temp. | | | Sheet resistance |
|---|---|---|---|---|
| Example | (deg. C.) | % T | % Shading | (Ohms/square) |
| 1 | 80 | 84.5 | * | 3.3 |
| 2 | 70 | 85.4 | * | 4.5 |
| 3 | 75 | 85.7 | * | 4.8 |
| 4 | 70 | 85.2 | * | 5.3 |
| 5 | 80 | 84.7 | * | 3.9 |
| 6 | 80 | 84.6 | * | 3.9 |
| 7 | 75 | 84.8 | 7.3 | 3.6 |
| 8 | 75 | 84.0 | 8.2 | 4.3 |
| 9 | 75 | 85.4 | 6.7 | 3.9 |
| 10 | 78 | 85.2 | 6.9 | 4.3 |
| 11 | 78 | 84.7 | 7.4 | 4.0 |
| 12 | 70 | 85.7 | 6.3 | 5.9 |
| 13 | 70 | 85.5 | 6.6 | 4.6 |
| 14 | 75 | 85.2 | 6.9 | 4.4 |
| 15 | 73 | 85.0 | 7.1 | 4.3 |

*: Not Calculated.

A number of embodiments of the invention have been described. Nevertheless, it will be understood that various modifications may be made without departing from the spirit and scope of the invention. Accordingly, other embodiments are within the scope of the following claims.

What is claimed is:

1. A composition comprising metal nanoparticles dispersed in a liquid carrier that includes a continuous liquid phase and a dispersed liquid phase, the composition being in the form of an emulsion,
wherein one of the continuous liquid phase or dispersed liquid phase comprises at least 40% by weight, based upon the total weight of the composition, of an aqueous phase, and the other of the continuous liquid phase or dispersed liquid phase comprises an oil phase that evaporates more quickly than the aqueous phase,
the metal nanoparticles being present in an amount no greater than 4% by weight, based upon the total weight of the composition,
wherein when the emulsion is coated onto a surface of a substrate and dried to remove the liquid carrier, the metal nanoparticles self-assemble to form a coating comprising a network-like pattern of electrically conductive traces defining cells that are transparent to light at wavelengths in the range of 370 to 770 nm,
the coating characterized as exhibiting a shading percentage of no greater than 8% and a sheet resistance of no greater than 50 ohms/square.

2. A composition according to claim 1, wherein the coating exhibits a shading percentage of no greater than 7%.

3. A composition according to claim 1, wherein the coating exhibits a sheet resistance of no greater than 20 ohms/square.

4. A composition according to claim 1, wherein the coating exhibits a sheet resistance of no greater than 10 ohms/square.

5. A composition according to claim 1, wherein the coating exhibits a sheet resistance of no greater than 5 ohms/square.

6. A composition according to claim 1, wherein the coating exhibits a sheet resistance of no greater than 4 ohms/square.

7. A composition according to claim 1, wherein the metal nanoparticles are present in an amount no greater than 2% by weight, based upon the total weight of the composition.

8. A composition according to claim 1, wherein the metal nanoparticles are present in an amount no greater than 1% by weight, based upon the total weight of the composition.

9. A composition according to claim 1, wherein the metal nanoparticles particles include a metal element selected from the group consisting of silver, gold, platinum, palladium, nickel, cobalt, copper, and combinations thereof.

10. A composition comprising metal nanoparticles dispersed in a liquid carrier that includes a continuous liquid phase and a dispersed liquid phase, the composition being in the form of an emulsion,
wherein one of the continuous liquid phase or dispersed liquid phase comprises at least 40% by weight, based upon the total weight of the composition, of an aqueous phase, and the other of the continuous liquid phase or dispersed liquid phase comprises an oil phase that evaporates more quickly than the aqueous phase,
the metal nanoparticles being present in an amount no greater than 4% by weight, based upon the total weight of the composition,
wherein when the emulsion is coated onto a surface of a substrate and dried to remove the liquid carrier, the metal nanoparticles self-assemble to form a coating comprising a network-like pattern of electrically conductive traces defining cells that are transparent to light at wavelengths in the range of 370 to 770 nm,
the coating characterized as exhibiting a shading percentage of no greater than 7% and a sheet resistance of no greater than 5 ohms/square.
